(19) United States
(12) Patent Application Publication
(10) Pub. No.: US 2006/0158478 A1
(43) Pub. Date: Jul. 20, 2006

(54) Circuit modeling and selective deposition

(76) Inventors: James John Howarth, Albuquerque, NM (US); Chuck Edwards, Rio Rancho, NM (US); Karel Vanheusden, Placitas, NM (US)

Correspondence Address: Jaimes Sher, Esq.;Cabot Corporation, 5401 Venice Avenue NE, Albuquerque, NM, 87113, US

(21) Appl. No.: 11/331,188

(22) Filed: Jan. 13, 2006

Related U.S. Application Data
(60) Provisional application No. 60/695,414, filed on Jul. 1, 2005.
(60) Provisional application No. 60/643,629, filed on Jan. 14, 2005.
(60) Provisional application No. 60/643,577, filed on Jan. 14, 2005.
(60) Provisional application No. 60/643,578, filed on Jan. 14, 2005.

(51) Int. Cl. B41J 29/393

(52) U.S. Cl. 347/19

(57) ABSTRACT

A process for fabricating an electrical component using an ink-jet printing process is provided. The process includes the steps of selecting at least one electronic ink having at least a first functionality when cured; determining a positional layout for a plurality of droplets of the electronic ink(s) such that, based at least on the first functionality, the positional layout provides a desired response for the electrical component; providing at least a first characteristic that relates to the electrical component; comparing the determined positional layout to at least one corresponding entry in a lookup table of empirical data relating to the first characteristic and to the determined positional layout; adjusting the determined positional layout accordingly; and printing each of the droplets of the electronic ink(s) onto a substrate according to the adjusted positional layout. The step of determining a positional layout may include determining a volume of ink to be deposited.

### CROSS-REFERENCE TO RELATED APPLICATIONS

This application claims priority to U.S. Provisional Patent Application Ser. Nos. 60/643,577; 60/643,378; and 60/643,629, all filed on Jan. 14, 2005, the entireties of which are incorporated herein by reference. This application also claims priority to U.S. Provisional Patent Application Ser. No. 60/695,414, filed on Jul. 1, 2005, the entirety of which is incorporated herein by reference.

### BACKGROUND OF THE INVENTION

1. Field of the Invention

The present invention relates to ink jet printing of electrical components. More particularly, the invention relates to a method and apparatus for printing electrical components onto a substrate using electronic inks that takes operational and environmental parameters into account in determining a positional layout of the electronic inks.

2. Related Art

The electronics, display and energy industries rely on the formation of coatings and patterns of conductive materials to form circuits on organic and inorganic substrates. The primary methods for generating these patterns are screen printing for features larger than about 100 μm and thin film and etching methods for features smaller than about 100 μm. Other subtractive methods to attain fine feature sizes include the use of photo-patternable pastes and laser trimming.

One consideration with respect to patterning of conductors is cost. Non-vacuum, additive methods generally entail lower costs than vacuum and subtractive approaches. Some of these printing approaches utilize high viscosity flowable liquids. Screen-printing, for example, uses flowable mediums with viscosities of thousands of centipoise. At the other extreme, low viscosity compositions can be deposited by methods such as ink-jet printing. However, low viscosity compositions are not as well developed as the high viscosity compositions.

Ink-jet printing of conductors has been explored, but the approaches to date have been inadequate for producing well-defined features with good electrical properties, particularly at relatively low temperatures.

There exists a need for compositions for the fabrication of electrical conductors for use in electronics, displays, and other applications. Further, there is a need for compositions that have low processing temperatures to allow deposition onto organic substrates and subsequent thermal treatment. It would also be advantageous if the compositions could be deposited with a fine feature size, such as not greater than about 100 μm, while still providing electronic features with adequate electrical and mechanical properties.

An advantageous metallic ink and its associated deposition technique for the fabrication of electrical conductors would combine a number of attributes. The electrical conductor would have high conductivity, preferably close to that of the pure bulk metal. The processing temperature would be low enough to allow formation of conductors on a variety of organic substrates (polymers). The deposition technique would allow deposition onto surfaces that are non-planar (e.g., not flat). The conductor would also have good adhesion to the substrate. The composition would desirably be inkjet printable, allowing the introduction of cost-effective material deposition for production of devices such as flat panel displays (PDP, AMLCD, OLED). The composition would desirably also be flexographic, gravure, or offset printable, again enabling lower cost and higher yield production processes as compared to screen printing.

Further, there is a need for electronic circuit elements, particularly electrical conductors, and complete electronic circuits fabricated on inexpensive, thin and/or flexible substrates, such as paper, using high volume printing techniques such as reel-to-reel printing. Recent developments in organic thin film transistor (TFT) technology and organic light emitting device (OLED) technology have accelerated the need for complimentary circuit elements that can be written directly onto low cost substrates. Such elements include conductive interconnects, electrodes, conductive contacts and via fills. In addition, there is a need to account for operational and environmental conditions in the manufacture of such circuit elements.

Existing printed circuit board technologies use process steps and rigidly define the printed circuit board in the context of layers. Only one layer of conductive material is permitted per layer due to the copper etch process used. In general, devices cannot be mounted on internal layers.

### SUMMARY OF INVENTION

In one aspect, the invention provides a process for fabricating an electrical component using an ink-jet printing process. The process includes the steps of: a) selecting at least one electronic ink having at least a first functionality when cured; b) determining a positional layout for a plurality of droplets of the at least one electronic ink such that, based at least on the first functionality, the positional layout provides a desired response for the electrical component; c) providing at least a first characteristic that relates to the electrical component; d) comparing the determined positional layout to at least one corresponding entry in a lookup table, the lookup table including empirical data relating to the first characteristic and to the determined positional layout; e) using a result of the comparing step to adjust the determined positional layout; and f) printing each of the plurality of droplets of the at least one electronic ink onto a substrate according to the adjusted positional layout. The step of determining a positional layout may include determining a volume of ink to be deposited. The step of using a result of the comparing step to adjust the determined positional layout may further include using a result of the comparing step to adjust the volume of ink to be deposited.

The step of determining a positional layout may include the steps of: i) determining a positional layout for deposition of a plurality of droplets of the at least one electronic ink onto a substrate; and ii) determining a thickness of the at least one electronic ink at each position on the substrate. The step of using a result of the comparing step to adjust the determined positional layout may further include using a result of the comparing step to adjust the thickness of the at least one electronic ink for at least one position on the substrate.

The positional layout may be three-dimensional. The step of determining a positional layout may further include providing a unique set of three coordinates to each droplet of the at least first electronic ink, wherein a first coordinate and a second coordinate jointly specify a unique position on a substrate and a third coordinate specifies an ink layer, wherein when two droplets have matching first and second coordinates, the droplet having a greater third coordinate is positioned directly above the droplet having a lesser third coordinate.

The step of using a result of the comparing step to adjust the determined positional layout may further include adjusting the determined positional layout by interpolating between at least two corresponding entries in the lookup table. The interpolating may be performed using a bilinear interpolation, a polynomial interpolation, a cubic spline interpolation, or using a Fourier transform. The step of using a result of the comparing step to adjust the determined positional layout may further include adjusting the determined positional layout by extrapolating from between the at least one corresponding entry in the lookup table. The comparing step may further include modeling a performance of the electrical component according to the determined positional layout in an electrical circuit and comparing a result of the modeling to a corresponding entry in the lookup table. The electrical component may be selected from the group consisting of a conductor, a resistor, a capacitor, an inductor, a transistor, a dielectric insulator, a sensor, a diode, a keyboard, an input device, a switch, a relay, a pixel, a data line, and a bus.

The first characteristic may be selected from the group consisting of: maximum allowable current flow; maximum allowable voltage drop; allowable signal frequency range; maximum allowable temperature rise; minimum allowable high voltage value; maximum allowable low voltage value; signal rise time; signal fall time; allowable impedance range; allowable resistance range; maximum allowable overshoot value; minimum allowable undershoot value; capacitance range; inductance range; operating temperature; and operating humidity. The lookup table may include empirical data relating to at least one of the group consisting of: a type of ink jet printer being used; a type of print head being used; a curing condition; a curing method being used; and a material characteristic of the at least one electronic ink. The electrical component may be an RFID antenna.

In another aspect, the invention provides a process for fabricating an electrical component using an ink-jet printing process. The process includes the steps of: a) providing a plurality of characteristics relating to the electrical component to a means for modeling an electrical circuit; b) using the means for modeling an electrical circuit to determine a positional layout for a plurality of droplets of each of at least one electronic ink such that the positional layout provides a desired response for the electrical component; and c) printing each of the plurality of droplets of the at least one electronic ink onto a substrate according to the determined positional layout. The step of using the means for modeling an electrical circuit to determine a positional layout may include determining a volume of ink to be deposited. The step of using the means for modeling an electrical circuit to determine a positional layout may include determining a thickness of the at least one electronic ink at each position within the positional layout.

The positional layout may be three-dimensional. The step of using the means for modeling an electrical circuit to determine a positional layout may further include providing a unique set of three coordinates to each droplet of the at least first electronic ink, wherein a first coordinate and a second coordinate jointly specify a unique position on the substrate and a third coordinate specifies an ink layer, wherein when two droplets have matching first and second coordinates, the droplet having a greater third coordinate is positioned directly above the droplet having a lesser third coordinate.

The step of using the means for modeling may further include the steps of: i) accessing a lookup table, the table including empirical data relating to the electrical component and at least one of the plurality of provided characteristics, ii) identifying at least two corresponding entries in the lookup table based on the electrical component and the plurality of provided characteristics; and iii) interpolating between the at least two corresponding entries to determine a portion of the positional layout. The interpolating may be performed using a bilinear interpolation, a polynomial interpolation, a cubic spline interpolation, or using a Fourier transform. The step of using the means for modeling may further include the steps of: i) accessing a lookup table, the table including empirical data relating to the electrical component and at least one of the plurality of provided characteristics, ii) identifying at least one corresponding entry in the lookup table based on the electrical component and the plurality of provided characteristics; and iii) extrapolating from the at least one corresponding entry in the lookup table to determine a portion of the positional layout.

The electrical component may be selected from the group consisting of a conductors, a resistor, a capacitor, an inductor, a transistor, a dielectric insulator, a sensor, a diode, a keyboard, an input device, a switch, a relay, a pixel, a data line, and a bus. At least one of the plurality of characteristics may be selected from the group consisting of: maximum allowable current flow; maximum allowable voltage drop; allowable signal frequency range; maximum allowable temperature rise; minimum allowable high voltage value; maximum allowable low voltage value; signal rise time; signal fall time; allowable impedance range; allowable resistance range; maximum allowable overshoot value; minimum allowable undershoot value; capacitance range; inductance range; operating temperature; and operating humidity. The means for modeling may include empirical data relating to at least one of the group consisting of: a type of ink jet printer being used; a type of print head being used; a curing condition; a curing method being used; and a material characteristic of the at least one electronic ink. The electrical component may be an RFID antenna.

In yet another aspect of the invention, a process is provided for constructing a circuit having a plurality of electrical components. The process includes the steps of: a) determining a positional layout of the circuit, the positional layout including positional data relating to each of a plurality of droplets of at least one electronic ink; b) ascertaining a plurality of operational characteristics relating to the circuit; c) simulating an operation of the circuit according to the determined positional layout and the ascertained operational characteristics; d) comparing a result of the simulating step to a corresponding entry in a library of empirical data; e) calibrating the determined positional layout using a result of the comparing step; and f) printing each of the plurality of droplets of the at least one electronic ink onto a substrate according to the calibrated positional layout. At least one of the plurality of electrical components may be selected from the group consisting of a conductor, a resistor, a capacitor, an inductor, a transistor, a dielectric insulator, a sensor, a diode, a keyboard, an input device, a switch, a relay, a pixel, a data line, and a bus.

At least one of the ascertained operational characteristics may be selected from the group consisting of: maximum allowable current flow; maximum allowable voltage drop; allowable signal frequency range; maximum allowable temperature rise; minimum allowable high voltage value; maximum allowable low voltage value; signal rise time; signal fall time; allowable impedance range; allowable resistance range; maximum allowable overshoot value; minimum allowable undershoot value; capacitance range; inductance range; operating temperature; and operating humidity. The simulating step may further include simulating an operation of the circuit according to the determined positional layout, the ascertained operational characteristics, and empirical data relating to at least one of the group consisting of: a type of inkjet printer being used; a type of print head being used; a curing condition; a curing method being used; and a material characteristic of the at least one electronic ink. At least one of the electrical components may be an RFID antenna.

### BRIEF DESCRIPTION OF THE DRAWINGS

FIG. 1 is a block diagram of an ink-jet printing system for printing electrical circuit elements onto a substrate using electronic inks according to a preferred embodiment of the present invention.

FIG. 2 is a flow chart that illustrates a method of printing an electrical circuit element onto a substrate using electronic inks whose layout is determined by taking into account various operational and environmental parameters, according to a preferred embodiment of the invention.

### DETAILED DESCRIPTION OF THE INVENTION

In an application of inkjet printing of electrical circuit elements onto a substrate, PCB or other layout tool software can be designed to allow for the input of a variety of requirements for a conductor, a dielectric, or an electrical component. These requirements may relate to such aspects as: 1) maximum level of current that will flow in the conductor, 2) maximum allowable voltage drop across the conductor in the application, 3) frequency of the signal that the conductor is carrying, 4) maximum allowable temperature rise of the conductor due to current transfer or frequency, 5) receiver minimum acceptable high voltage value, 6) receiver maximum acceptable low voltage value, 7) rise and fall time of a driven signal, 8) minimum and maximum voltage level of the driven signal, 9) desired impedance of a trace, 10) desired resistance of the trace, 11) acceptable overshoot and undershoot values that are allowable at the drive and receiver, 12) capacitance range, and 13) inductance range. Additional input parameters may also include environmental conditions of the device utilizing ink jet printable materials, such as, for example, operating conditions such as temperature and humidity.

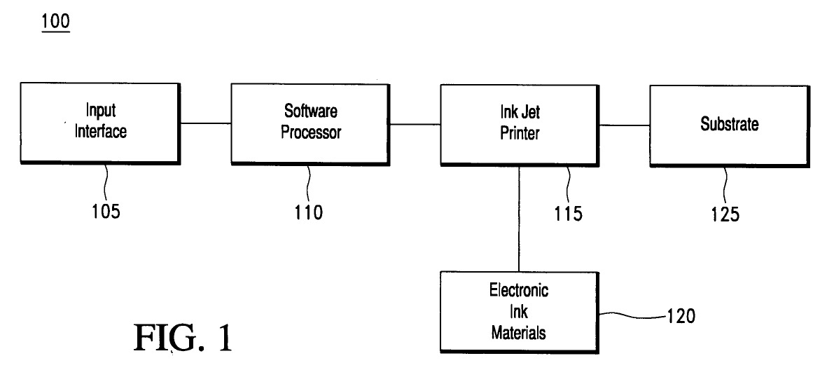

Referring to FIG. 1, a system 100 according to a preferred embodiment of the present invention is illustrated. Using an input interface 105, one or more of the above-listed parameters may be fed back into circuit modeling software which is processed in a software processor 110, such as a multi-purpose computer. The processor 110 uses the circuit modeling software to determine how much electronic ink material should be deposited on a substrate to form an electrical circuit element that will meet and/or exceed the specifications for that element. The processor 110 then instructs an ink jet direct write device 115, via an electronic file such as a computer program, to deposit the exact amount of material necessary to meet the specifications, thus depositing only the necessary amount of electronic ink material 120 onto a substrate 125. Other inputs provided by the circuit designer into the software may provide width and height information to the printer 115 which, in turn, determines the amount of electronic ink material 120 that should be deposited onto the substrate 125 for a given conductive trace. For example, a trace designed to carry relatively high values of electrical current may require several depositions, or passes of an ink jet head, to deposit sufficient electronic ink material 120 to meet a specified requirement. As another example, a trace designed to carry relatively low values of current at a relatively low frequency may be fabricated with only a single pass of a ink jet deposition device. In some manufacturing systems, an ink jet print head may be selected for the sole purpose of depositing the minimum amount of material onto the substrate 125. The ink jet printer 115 can then be instructed via the software processor 110 to perform two or more passes over areas of the electronic circuit requiring more material to meet the specifications provided by the user. The circuit modeling software can also provide information back to the user regarding the manufacturing process, providing information either in real time or via reports that indicate how much material will be required in certain areas of the electrical circuit. Typically, the circuit modeling software may include at least three components: 1) a symbol library, which uses schematic symbols to design and draw a circuit using a CAD system; 2) circuit simulation software to simulate the performance of the designed circuit; and 3) a layout library, which translates the designed circuit into a layout for the electronic inks.

The circuit modeling software may also utilize predetermined characterization data for depositions of various electronic inks onto different types of substrates. Experimentation may be performed to determine optimal processing techniques for electronic inks onto certain substrates. For example, a design process for the fabrication of silver conducting traces on a polyimide substrate would include using a look-up table of data from previous experiments to determine an expected range of process variations for electrical devices on this type of substrate. Process variations may be determined from experiments relating to a variety of different ink jet printing devices, different print head devices, and different curing conditions. Such curing conditions may include temperature, the duration of the cure at that temperature, and the type of gas in which the material is cured. Different curing methods, such as laser, infrared, microwave, hot air, inductive heating, and others may also be included in the look-up table of resultant experimental data to provide a user with performance results, either in real time or via post-process reporting by the software tool. Variations in the electronic ink material may also be factored into the circuit modeling software to ensure reliable fabrication of electronic devices via ink jet printing. In a preferred embodiment of the invention, all of the previously mentioned variables would, through extensive experimentation, be included for all practical conditions of use in a software look-up table that would provide feedback to both the user and ink jet print device to optimize both electrical performance as well as manufacturing throughput.

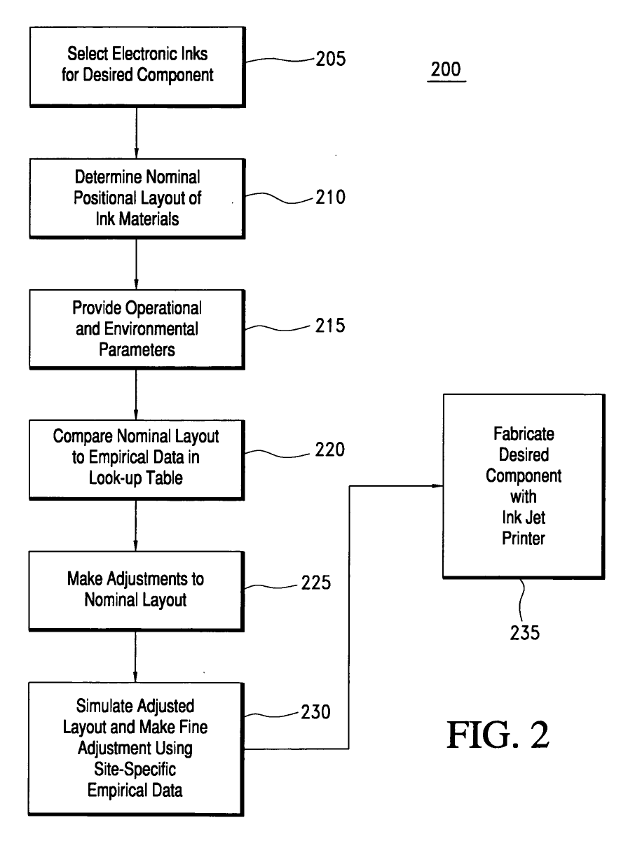

Referring to FIG. 2, a flow chart 200 illustrates a method of fabricating an electrical circuit element using an ink jet printer according to a preferred embodiment of the present invention. The first step 205 involves selecting one or more electronic inks to be used in fabricating a desired component, such as a conductor, a resistor, a capacitor, or an inductor. When cured, each of the electronic inks exhibits a known electrical characteristic, such as resistivity, conductivity, permittivity, or permeability. Then, in step 210, a nominal positional layout of the inks is determined, using the known electrical characteristics of the selected inks. For example, a resistive ink can be used to print a resistor, and its nominal positional layout determines a length and a cross-sectional area, from which the resistance can be calculated.

At step 215, a set of operational and environmental parameters is provided, for example, to the software processor 110. The parameters may include one of more of the exemplary parameters discussed above. Then, at step 220, the nominal positional layout is compared to empirical data relating to the provided parameters that has been compiled in a look-up table. Using this empirical data, adjustments to the nominal positional layout are made at step 225. It is noted that the look-up table of empirical data is typically being updated on an ongoing basis, in order that this data is fresh and accurate. Then, at step 230, a second, fine adjustment is made using site-specific empirical data applied to a simulation of the circuit. This is especially useful when the circuit has been designed at one location but the fabrication is to take place at a second location, such as a manufacturing facility. The manufacturing facility may have site-specific empirical data that is useful to make the performance of a simulated circuit more accurate, especially with respect to sensitive inks such as resistive inks and dielectric inks. In many instances, the fine adjustment will only affect the z-dimension, i.e., the number of layers of a given ink at a given point on the substrate. Then, at step 235, the adjusted positional layout is provided to the ink jet printer, which then deposits the selected inks onto a substrate based on the adjusted positional layout. In this manner, the desired electrical circuit element is fabricated with a high degree of precision, taking all operational and environmental parameters into account. Optionally, the printed circuit can also be tested for accuracy by taking measurements of various circuit elements, and a third adjustment can be made using the measurements, followed by a reprinting of the circuit.

The empirical data in the lookup table typically includes data for each of the relevant parameters in relation to a range of values for a given component. For example, for a resistor, a range of values is provided, and a step is also provided. For example, the range may be 100 ohms to 1000 ohms in 25-ohm steps, and then 1000 ohms to 10,000 ohms in 250-ohm steps. For each step, a value of each relevant parameter is also provided. The accuracy of the empirical data will increase as the step size decreases, because there will be more data points. However, more data also results in a more time-consuming and expensive process. Interpolation can be used when a design value falls between two steps. For example, if a resistor value according to the nominal circuit design is 540 ohms, and the table includes values relating to 525 ohms and 550 ohms, then the parameter values can be interpreted between these two points. Typical interpolation methods include bilinear interpolation, polynomial interpolation, cubic spline interpolation, and Fourier transform.

The method of depositing only the required amount of electronic ink material according to the present invention represents a significant advance with respect to conventional processes of creating patterns on printed circuit boards in which copper-clad laminated sheets of FR4 are typically patterned in a photolithography process, and then material is subtracted from the substrate to form the conductive traces. This subtractive process is undesirable since much waste is created, thus requiring expensive disposal methods. In contrast, the method of the present invention is strictly an additive process that allows all electrical performance requirements to be met or exceeded. This advantage is provided by the present invention because ink jet deposition of material allows for flexible deposition of material, as well as the ability to overprint, or to add material at the same location to meet a requirement. For example, a radio-frequency identification (RFID) antenna may require certain portions of the antenna to be more conductive than other parts of the antenna. Ink jet deposition of materials allows for selective deposition of material, thus providing more material to the portions of the antenna that require more material, while depositing only the minimum amount of material necessary for other portions of the antenna. A second example involves traces on a printed circuit board. Some traces may require more material due to a higher required current carrying capability. A third example is the ability to tailor the thickness of a resistor, either to modify the resistance value or to increase the allowable power handling capability of that resistor.

A similar process can be used for fabrication of capacitors using ink jet printing technology. Several parameters, such as the desired capacitance, maximum area of the capacitor of the application, desired effective series resistance of the capacitor, desired maximum operating voltage for the capacitor, desired height of capacitor, and desired number of layers for the capacitor, may all be provided as inputs to circuit modeling software. The software then determines from the user input how to fabricate the capacitor using an ink jet print system. For example, a set of inputs may be provided to the software, including a capacitance value, maximum allowable dimensions in the x and y directions, maximum allowable number of layers of the capacitor, maximum height of capacitor, maximum allowable effective series resistance, and minimum operating voltage. The software then provides to the ink jet tool the x and y dimensions of a parallel plate capacitor (or an interdigitated capacitor, if desired), the number of times to overprint the electrodes of the capacitor (with a minimum of at least one layer deposition for the electrode) to achieve a value of effective series resistance, the number of layers in the capacitor to achieve the capacitance value, and the thickness of the dielectric material based on the capacitance value and the minimum operating voltage. In some circumstances, the software may indicate to the user that a capacitor having the desired characteristics cannot not be designed based on the parameters provided. In that situation, the software may indicate an error to the user. The software may also perform these calculations in real time, thus providing immediate feedback to the user when the provided parameters result in a design rule error. Typically, the software provides to the user the dimensions of the capacitor, shown graphically via graphical user interface, and thereby enables placement of the capacitor in a printed circuit computer aided design (CAD) layout tool.

A similar process can be used for fabrication of resistors. For example, various parameters may be provided as user inputs to the software. These parameters may include the desired resistor value, desired maximum resistor area on substrate, and the desired power handling capability of the resistor. The software then provides the dimensions of the resistor and the necessary thickness of the resistor. In some instances, the software may report back to the user via either real-time or post-process reporting that the desired resistor conflicts with the parameters provided by the user. In addition, the software tool may indicate to the user, via graphical user interface, the dimensions of the requested ink jetted resistor. This may enable the user to perform device placement in a printed circuit CAD layout tool.

A similar process can be used for fabrication of inductors. The user provides input parameters to a software tool. These performance parameters may include an inductance, a desired area of the inductor, a desired number of inductor turns, and parameters relating to the architecture of the inductor. Architecture-related parameters may specifically include whether the inductor is a coil of wire around a core of magnetic material, and whether this core is designed as a bar, a toroid, or a circular pattern, with coils for the inductor extending in a circular fashion with additional circular coils fabricated above or below the said coil, and with all coils surrounded by a magnetic material. Other input parameters may include a desired series resistance of the conducting material, which may also be deposited via ink jet device. The software tool provides information as to whether or not the desired inductor can be fabricated based on the user input. If the inductor can be fabricated, the dimensions of the device may be displayed via graphical user interface by the software tool, and device placement may occur via printed circuit board layout tool. In a similar fashion, the described methodology could be extended to the fabrication of other magnetic or inductive electrical devices, such as transformers and circulators.

In some cases, the described software tool may be part of another printed circuit layout tool, simulation tool, or a combination of the two. In some cases, the described software tool may be a totally separate or independent program that exports files containing information that can be utilized by other software tools. Examples of such a software tool may include Mentor Graphics Expedition series software or Cadence layout software. The described software tool may act as a compiler for ink jet printed electrical circuit elements, exporting to the software tool information about the dimensions of each element and the location on the substrate at which each of the electronic ink materials should be deposited in order to fabricate each element.

Ink jet printers may be operated in a range of environments. These environments may have different temperatures and humidity levels depending on the location or time of year at which the printer is operating. Due to the dynamic nature of the operating environment, calibration methods may be required to ensure a uniform material deposition method throughout the operation of the ink jet printer.

Calibration targets may consist of test patterns comprising conductors, resistors, capacitors, and inductors that are deposited onto a substrate for the sole purpose of calibrating the ink jet printer. Such a test pattern may, for example, comprise several versions of each of the aforementioned electrical components. After deposition of these components, a temperature cure of the test pattern is typically performed. The temperature cure may be virtually identical to a normal manufacturing process flow, or may instead be a shortened cure cycle to allow for rapid calibration in order to maximize productivity. Interpolation may also be used to make modifications. Elements that are used in a calibration step having a shortened cure cycle may require having their values interpolated based on previously performed experiments performed with the same electronic ink material at shortened cure times. Once the cure step is completed, measurements are taken on the deposited devices that include electrical characterization data such as resistance, impedance, capacitance, and inductance. Furthermore, optical evaluation of the deposited elements may be performed in order to measure the dimensions of each element in the x, y and z directions to determine how close the dimensions of the test elements match the desired and predicted element dimensions. Once this information has been gathered, modifications to the ink jet deposition device can be made to modify the amount of material deposited by each ink jet nozzle, the velocity of the ink drop deposited by the ink jet head, the volume of material, the temperature of the material, and ink jet head parameters such as rise time and fall time, drive voltage, drive pulse duration, and drive frequency. Additionally, the temperature of the substrate or platen of the ink jet device may be modified. The temperature inside the ink jet device chamber may also be modified, and the humidity of the ink jet device chamber may be modified.

In instances in which blends of inks on are deposited onto different substrates, multiple test points may be needed across the range of head nozzles to provide feedback to the print head device to maintain accuracy of the printed elements.

Variations in materials such as inks, print heads, and substrate variations may also be included as part of the calibration of an ink jet printer. These variations, which can be bounded through resulting experiments of the described manufacturing process, must be taken into account in the fabrication of electrical circuit elements via ink jet printer. Look-up tables and back annotation can be used to compensate for variations in values of different circuit elements. Bed of nails testing or flying probe testing can be used to efficiently test arrays of circuit elements, such as resistors, capacitors, and inductors created via ink jet printing.

Feedback to the design system may include information about the capabilities of the ink jet printer. For example, such information may include specifying a layer thickness that the ink jet printer is not capable of, specifying a resolution which the ink jet printer is not capable of, and/or specifying a range of values for components that would not be allowable given the capabilities of the printer. In a preferred embodiment, a set of design rules that take into account the capabilities of the print system are used. The raster image processor (RIP) processes the image created by the design system into a format that is acceptable to the printer. The RIP then translates the design into movements and instructs the print head when and when not to deposit material.

Determination of the final value of a resistor, capacitor, or inductor can be performed using intermediate cure stages. For example, a fast cure process can be used to simply dry the material in order to allow testing of the component. After this fast cure process, defined by curing for a duration of time less than the time required to fabricate the final component, the components may be measured to determine intermediate component values at this stage. These intermediate values can then be used to predict final component values that will result during a final cure step. Additionally, these intermediate values may be used for the prediction of defective components, thus allowing for immediate remediation, rather than remediation after a full duration cure process. Empirical data to be used for predicting final values of components is obtained through a comprehensive set of experiments using a range of cure times and a range of cure temperatures. In some instances, component values may only be measured at the termination of the process, and components determined to be defective can either be reworked or discarded. Modifications to the cure process may be made at intermediate steps that allow for components to reach their target values based on the measured values obtained during intermediate measurements.

Surface roughness of the substrate can have a significant impact on the performance of ink jetted printable electrical circuit elements, and therefore is a necessary part of a calibration process. In addition, substrate surface roughness should be accounted for in the software used for designing these circuit elements. In some instances, surface roughness information may be provided to a software tool as part of a look-up table of statistical measurements of surface roughness on various substrates. In other instances, surface roughness of the substrate may be taken into account via calibration at time of manufacturing. Such a calibration requires measurements of surface roughness to be taken before fabrication of the circuit element. Surface roughness of the substrate may be addressed by deposition of additional electronic ink material for smoothing of the desired deposition area. Additionally, surface roughness may be addressed by mechanical polishing of the substrate, or a passivation/planarization material may be deposited to decrease the roughness of the substrate. In some instances, surface roughness may be addressed via laser ablation of the substrate material.

Drops from an ink jet printer may be inspected visually. For example, a high speed camera may be used for such an inspection. The camera can capture image data relating to many different attributes about the ink drop, including drop size, the quality of the drop, the formation of satellites, the velocity of the drop compared to the expected drop velocity given a density of the material, and the direction the drop is traveling in to determine whether or not any deviation in the desired direction has occurred. The ink drop can also be examined on the substrate medium to determine the amount of spreading and quality of the deposited drop on the substrate.

More advanced methods may be used to determine the weight of the drop to determine whether the ink is at the specified density. A single drop can be put through a test cure process and be compared visually by examining drop volume and comparing that volume to previously measured drops throughout the whole history of fabrication with a specific ink jet printer. Other advanced methods can be used to detect the density of the drop by using drops that have been electrically charged, where the magnitude of the charge is proportional to the amount of solid material inside the drop. The charge may be detected due to the magnetic field produced while the ink drop travels from the print head to the substrate.

Density of the drop and the electronic ink material may be maintained at a higher level of precision by using a circulation system in the ink jet printer. Density of the drop may also be determined by examining the resulting velocity of the drop imparted by the piezo ink jet head, or by weighing the drop before and after a cure step. Density or weight of a drop from a given nozzle may potentially be determined by a MEMS device. Optical density of the electronic ink material can be measured to determine the distribution of drop sizes for use in calibration of the device.

Directionality of the imparted drop may also be a source of error in ink jet print systems. This directionality error may result from tolerances in the print head nozzles, manufacturing variation in print head nozzles, variations in the velocity of the printing stage, and/or airflow inside the printing chamber. Calibration of a printed substrate is critical for printed electronics. Such a calibration can be carried out optically by examination of the reflected light from a source, such as a light-emitting diode (LED) or laser, and evaluating the returned light signature to examine the extent of the directionality error. Adjustments can then be made. In addition, the printed substrate may be scanned using a commercially available scanner or similar device, and the drop locations analyzed for errors. A feedback loop may be employed that examines the drop locations via optical examination, and then makes adjustments to the print head nozzle ink drop velocity and adjustments to the velocity of the printing stage, in order to provide compensation for the directionality error of the print head. Additional information relating to directionality and characterization of ink-jetted drops may be found in Published U.S. Patent Application Nos. US 2004/0231594A1 and US 2004/0173144A1, the contents of each of which are incorporated herein by reference.

The electronic ink may be calibrated at an end user's location to produce optimum results. For example, blending of different types of materials may be performed to create inks having highly precise electrical characteristics after curing. A feedback loop that includes, for example, a print step of the initial material, a cure step, a measurement step, and an ink adjustment step such as the addition of another ink or solvent into the primary ink, may be employed in order to compensate for differences between the actual and desired values. This process may be repeated until the desired results are produced.

Ink containers may be labeled with electronically readable information that indicates whether a particular electronic ink can be used in a specific ink jet printer. Different ink jet heads may be required for different materials, and therefore, the possibility of using an ink jet head not designed for a particular ink could cause irreversible damage to that ink jet head. A label may also indicate ranges of allowable environmental conditions, such as temperatures. In turn, the printer may be enabled to alert the operator that the allowable environmental conditions have been exceeded for that ink material. Label information may also include required recirculation rates, shelf life, and/or operation life for a specific ink. The label may also include lot information, batch operation, and/or manufacturing time and date information. The label information can be sent electronically to ink manufacturer together with results from calibration operations for quality control and improvement.

While the present invention has been described with respect to what is presently considered to be the preferred embodiment, it is to be understood that the invention is not limited to the disclosed embodiments. To the contrary, the invention is intended to cover various modifications and equivalent arrangements included within the spirit and scope of the appended claims. The scope of the following claims is to be accorded the broadest interpretation so as to encompass all such modifications and equivalent structures and functions.

What is claimed is:

1. A process for fabricating an electrical component using an ink-jet printing process, comprising the steps of:
a) selecting at least one electronic ink having at least a first functionality when cured;
b) determining a positional layout for a plurality of droplets of the at least one electronic ink such that, based at least on the first functionality, the positional layout provides a desired response for the electrical component;
c) providing at least a first characteristic that relates to the electrical component;
d) comparing the determined positional layout to at least one corresponding entry in a lookup table, the lookup table including empirical data relating to the first characteristic and to the determined positional layout;
e) using a result of the comparing step to adjust the determined positional layout; and
f) printing each of the plurality of droplets of the at least one electronic ink onto a substrate according to the adjusted positional layout.

2. The process of claim 1, wherein the step of determining a positional layout includes determining a volume of ink to be deposited.

3. The process of claim 2, wherein the step of using a result of the comparing step to adjust the determined positional layout further comprises using a result of the comparing step to adjust the volume of ink to be deposited.

4. The process of claim 2, wherein the step of determining a positional layout includes the steps of:
i) determining a positional layout for deposition of a plurality of droplets of the at least one electronic ink onto a substrate; and
ii) determining a thickness of the at least one electronic ink at each position on the substrate.

5. The process of claim 4, wherein the step of using a result of the comparing step to adjust the determined positional layout further comprises using a result of the comparing step to adjust the thickness of the at least one electronic ink for at least one position on the substrate.

6. The process of claim 1, the positional layout being three-dimensional, and the step of determining a positional layout further comprising providing a unique set of three coordinates to each droplet of the at least first electronic ink,
wherein a first coordinate and a second coordinate jointly specify a unique position on a substrate and a third coordinate specifies an ink layer, wherein when two droplets have matching first and second coordinates, the droplet having a greater third coordinate is positioned directly above the droplet having a lesser third coordinate.

7. The process of claim 1, wherein the step of using a result of the comparing step to adjust the determined positional layout further comprises adjusting the determined positional layout by interpolating between at least two corresponding entries in the lookup table.

8. The process of claim 7, wherein the interpolating is performed using one of a bilinear interpolation, a polynomial interpolation, or a cubic spline interpolation.

9. The process of claim 7, wherein the interpolating is performed using a Fourier transform.

10. The process of claim 1, wherein the step of using a result of the comparing step to adjust the determined positional layout further comprises adjusting the determined positional layout by extrapolating from between the at least one corresponding entry in the lookup table.

11. The process of claim 1, wherein the comparing step further comprises modeling a performance of the electrical component according to the determined positional layout in an electrical circuit and comparing a result of the modeling to a corresponding entry in the lookup table.

12. The process of claim 1, wherein the electrical component is selected from the group consisting of a conductor, a resistor, a capacitor, an inductor, a transistor, a dielectric insulator, a sensor, a diode, a keyboard, an input device, a switch, a relay, a pixel, a data line, and a bus.

13. The process of claim 1, wherein the first characteristic is selected from the group consisting of:
maximum allowable current flow;
maximum allowable voltage drop;
allowable signal frequency range;
maximum allowable temperature rise;
minimum allowable high voltage value;
maximum allowable low voltage value;
signal rise time;
signal fall time;
allowable impedance range;
allowable resistance range;
maximum allowable overshoot value;
minimum allowable undershoot value;
capacitance range;
inductance range;
operating temperature; and
operating humidity.

14. The process of claim 1, wherein the lookup table includes empirical data relating to at least one of the group consisting of: a type of ink jet printer being used; a type of print head being used; a curing condition; a curing method being used; and a material characteristic of the at least one electronic ink.

15. The process of claim 1, wherein the electrical component comprises an RFID antenna.

16. A process for fabricating an electrical component using an ink-jet printing process, comprising the steps of:
a) providing a plurality of characteristics relating to the electrical component to a means for modeling an electrical circuit;
b) using the means for modeling an electrical circuit to determine a positional layout for a plurality of droplets of each of at least one electronic ink such that the positional layout provides a desired response for the electrical component; and
c) printing each of the plurality of droplets of the at least one electronic ink onto a substrate according to the determined positional layout.

17. The process of claim 16, wherein the step of using the means for modeling an electrical circuit to determine a positional layout includes determining a volume of ink to be deposited.

18. The process of claim 17, wherein the step of using the means for modeling an electrical circuit to determine a positional layout includes determining a thickness of the at least one electronic ink at each position within the positional layout.

19. The process of claim 16, the positional layout being three-dimensional, and the step of using the means for modeling an electrical circuit to determine a positional layout further comprising providing a unique set of three coordinates to each droplet of the at least first electronic ink,
wherein a first coordinate and a second coordinate jointly specify a unique position on the substrate and a third coordinate specifies an ink layer, wherein when two droplets have matching first and second coordinates, the droplet having a greater third coordinate is positioned directly above the droplet having a lesser third coordinate.

20. The process of claim 16, wherein the step of using the means for modeling further comprises the steps of:
i) accessing a lookup table, the table including empirical data relating to the electrical component and at least one of the plurality of provided characteristics,
ii) identifying at least two corresponding entries in the lookup table based on the electrical component and the plurality of provided characteristics; and
iii) interpolating between the at least two corresponding entries to determine a portion of the positional layout.

21. The process of claim 20, wherein the interpolating is performed using one of a bilinear interpolation, a polynomial interpolation, or a cubic spline interpolation.

22. The process of claim 20, wherein the interpolating is performed using a Fourier transform.

23. The process of claim 16, wherein the step of using the means for modeling further comprises the steps of:
i) accessing a lookup table, the table including empirical data relating to the electrical component and at least one of the plurality of provided characteristics,
ii) identifying at least one corresponding entry in the lookup table based on the electrical component and the plurality of provided characteristics; and
iii) extrapolating from the at least one corresponding entry in the lookup table to determine a portion of the positional layout.

24. The process of claim 16, wherein the electrical component is selected from the group consisting of a conductor, a resistor, a capacitor, an inductor, a transistor, a dielectric insulator, a sensor, a diode, a keyboard, an input device, a switch, a relay, a pixel, a data line, and a bus.

25. The process of claim 16, wherein at least one of the plurality of characteristics is selected from the group consisting of:
maximum allowable current flow;
maximum allowable voltage drop;
allowable signal frequency range;
maximum allowable temperature rise;
minimum allowable high voltage value;
maximum allowable low voltage value;
signal rise time;
signal fall time;
allowable impedance range;
allowable resistance range;
maximum allowable overshoot value;
minimum allowable undershoot value;
capacitance range;
inductance range;
operating temperature; and
operating humidity.

26. The process of claim 16, wherein the means for modeling includes empirical data relating to at least one of the group consisting of: a type of ink jet printer being used; a type of print head being used; a curing condition; a curing method being used; and a material characteristic of the at least one electronic ink.

27. The process of claim 16, wherein the electrical component comprises an RFID antenna.

28. A process for constructing a circuit having a plurality of electrical components, the process comprising the steps of:
a) determining a positional layout of the circuit, the positional layout including positional data relating to each of a plurality of droplets of at least one electronic ink;
b) ascertaining a plurality of operational characteristics relating to the circuit;
c) simulating an operation of the circuit according to the determined positional layout and the ascertained operational characteristics;
d) comparing a result of the simulating step to a corresponding entry in a library of empirical data;
e) calibrating the determined positional layout using a result of the comparing step; and
f) printing each of the plurality of droplets of the at least one electronic ink onto a substrate according to the calibrated positional layout.

29. The process of claim 28, wherein at least one of the plurality of electrical components is selected from the group consisting of a conductor, a resistor, a capacitor, an inductor, a transistor, a dielectric insulator, a sensor, a diode, a keyboard, an input device, a switch, a relay, a pixel, a data line, and a bus.

30. The process of claim 28, wherein at least one of the ascertained operational characteristics is selected from the group consisting of:
maximum allowable current flow;
maximum allowable voltage drop;
allowable signal frequency range;
maximum allowable temperature rise;
minimum allowable high voltage value;
maximum allowable low voltage value;
signal rise time;
signal fall time;
allowable impedance range;
allowable resistance range;
maximum allowable overshoot value;
minimum allowable undershoot value;
capacitance range;
inductance range;
operating temperature; and
operating humidity.

31. The process of claim 28, wherein the simulating step further comprises simulating an operation of the circuit according to the determined positional layout, the ascertained operational characteristics, and empirical data relating to at least one of the group consisting of: a type of ink jet printer being used; a type of print head being used; a curing condition; a curing method being used; and a material characteristic of the at least one electronic ink.

32. The process of claim 28, wherein at least one of the electrical components comprises an RFID antenna.
